(19) United States
(12) Patent Application Publication
(10) Pub. No.: US 2022/0131243 A1
(43) Pub. Date: Apr. 28, 2022

(54) Rechargeable-battery fuse

(71) Applicant: Hilti Aktiengesellschaft, Schaan (LI)

(72) Inventors: Rene RICHTER, Augsburg (DE); Andreas GUGGEMOS, Bad Woerishofen (DE); Michael NITZSCHNER, Augsburg (DE)

(21) Appl. No.: 17/429,392

(22) PCT Filed: Mar. 2, 2020
(86) PCT No.: PCT/EP2020/055383

§ 371 Date: Aug. 9, 2021

(30) Foreign Application Priority Data
Mar. 11, 2019 (EP) 19161802.4

(51) Int. Cl. H01M 50/583

(52) U.S. Cl. CPC H01M 50/583; H01M 2220/30; H01M 2200/103

(57) ABSTRACT

Rechargeable battery, in particular for supplying a machine tool with electrical power, comprising a housing for accommodating at least one energy storage cell, and a positive line and a negative line for connecting the at least one energy storage cell to an interface device. The rechargeable battery contains at least one overcurrent protection device in the positive line or in the negative line.

The present invention relates to a rechargeable battery, in particular for supplying a machine tool with electrical power, comprising a housing for accommodating at least one energy storage cell, and a positive line and a negative line for connecting the at least one energy storage cell to an interface device.

### BACKGROUND

Rechargeable batteries available on the market usually contain a multiplicity of energy storage cells, also called rechargeable battery cells, which are used for storing and releasing electrical energy. The housing of the rechargeable battery usually consists of a relatively hard plastics shell. For example, the hard plastic may be polyamide, polycarbonate or the like.

Both the power and the capacity (in ampere hours, Ah) of modern rechargeable batteries are constantly increasing. Extensive and complex measures are usually taken to guarantee or further increase safety when working with these rechargeable batteries.

### SUMMARY OF THE INVENTION

It is an object of the present invention to solve the aforementioned problem and to provide a rechargeable battery at a greater level of safety.

The present invention provides a rechargeable battery, in particular for supplying a machine tool with electrical power, comprising a housing for accommodating at least one energy storage cell, and a positive line and a negative line for connecting the at least one energy storage cell to an interface device.

The rechargeable battery contains at least one overcurrent protection device in the positive line or in the negative line.

The overcurrent protection device may also be referred to as a fuse or a cutout or as an OCP device.

According to an advantageous embodiment of the present invention, it is possible that at least one overcurrent protection device is contained both in the positive line and in the negative line. This can further increase the safety of the rechargeable battery.

According to an advantageous embodiment of the present invention, it may be possible for at least two overcurrent protection devices, arranged in parallel with one another, to be contained in the positive line or in the negative line. The special arrangement and/or the increase in the number of overcurrent protection devices allows a further increase in the safety of the rechargeable battery.

According to an advantageous embodiment of the present invention, it is possible that the overcurrent protection device is embodied as a fusible link.

The overcurrent protection device may be embodied, for example, as a fusible link, electronic fuse, SMD (surface-mounted device), self-resetting fuse, circuit breaker or as an electrical resistor. In addition, the overcurrent protection device may also be embodied as a narrowing in a cell connector and/or as a narrowing of a current-carrying path on a printed circuit board.

Further advantages will become apparent from the following description of the figures. Various exemplary embodiments of the present invention are illustrated in the figures. The figures, the description and the claims contain numerous features in combination. A person skilled in the art will expediently also consider the features individually and combine them to produce useful further combinations.

### BRIEF DESCRIPTION OF THE DRAWINGS

In the figures, identical and similar components are denoted by identical reference signs.

In the figures:

FIG. 1 shows a side view of a machine tool in the form of a battery-operated screwdriver connected to a rechargeable battery;

FIG. 2 shows a sectional side view of the rechargeable battery comprising a first row and second row of energy storage cells, a control device, an interface device, a first overcurrent protection device in the positive line, and a second overcurrent protection device in the negative line;

FIG. 3 shows a perspective view through the housing of the rechargeable battery comprising a first row and second row of energy storage cells, an interface device, a first overcurrent protection device in the positive line, and a second overcurrent protection device in the negative line;

FIG. 4 shows a schematic circuit diagram of the rechargeable battery according to the invention according to a first exemplary embodiment;

FIG. 5 shows a schematic circuit diagram of the rechargeable battery according to the invention according to a second exemplary embodiment;

FIG. 6 shows a schematic circuit diagram of the rechargeable battery according to the invention according to a third exemplary embodiment;

FIG. 7 shows a schematic circuit diagram of the rechargeable battery according to the invention according to a fourth exemplary embodiment;

FIG. 8 shows a schematic circuit diagram of the rechargeable battery according to the invention according to a fifth exemplary embodiment; and

FIG. 9 shows a schematic circuit diagram of the rechargeable battery according to the invention according to a sixth exemplary embodiment.

### DETAILED DESCRIPTION

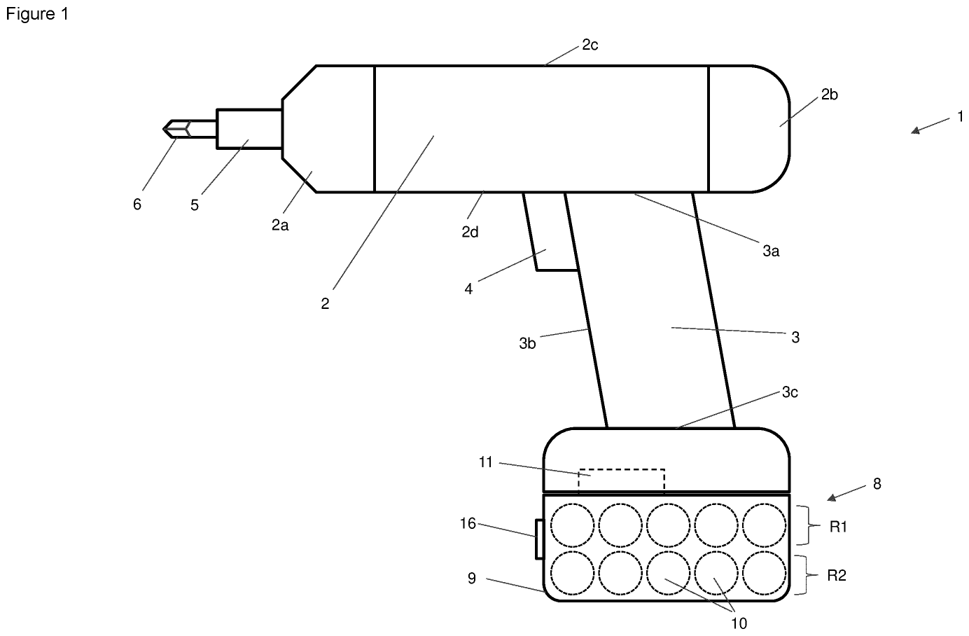

FIG. 1 shows a schematic representation of a machine tool 1 in the form of a battery-operated screwdriver. It is also possible, however, for the machine tool 1 to be embodied in the form of a power drill, a saw, an angle grinder or the like.

The machine tool 1 embodied as a battery-operated screwdriver essentially contains a housing 2, in which a drive in the form of an electric motor, gearing, a drive shaft and a controller are contained, and a handle 3, an operating switch 4 and a tool holder 5. The drive, the gearing, the drive shaft and the controller are not shown in the figures.

The housing 2 contains a front end 2a, a back end 2b, an upper face 2c and a lower face 2d. The tool holder 5, which is used to receive and hold a tool 6, is provided at the front end 2a of the housing 2. The tool 6 is embodied here as a screwdriver bit.

The handle 3 is connected by a first, top end 3a to the lower face 2d of the housing 2. The operating switch 4 of the machine tool 1 is positioned on a front face 3b of the handle 3 and is used for activating the machine tool 1. A battery interface 7 is contained at a second, bottom end 3c of the handle 3. The battery interface 7 contains a positive contact and negative contact and is used for re-releasable connection of a rechargeable battery 8 to the machine tool 1. The connected rechargeable battery 8 can supply electrical power to the machine tool 1.

As can be seen from FIGS. 1 to 3, the rechargeable battery 8 contains essentially a housing 9 (also called a battery housing), a number of energy storage cells 10 (also called rechargeable battery cells), an interface device 11, a positive line 12 (also called a positive path, positive wire or positive cable), a negative line 13 (also called a negative path, negative wire or negative cable), and a battery controller 14 (also called a CMS or cell management system).

The energy storage cells 10 may be embodied in the form of cylindrical rechargeable battery cells or in the form of what are known as “pouch cells”.

The battery controller 14 is substantially in the form of a printed circuit board (also known as a PCB, printed circuit or circuit board).

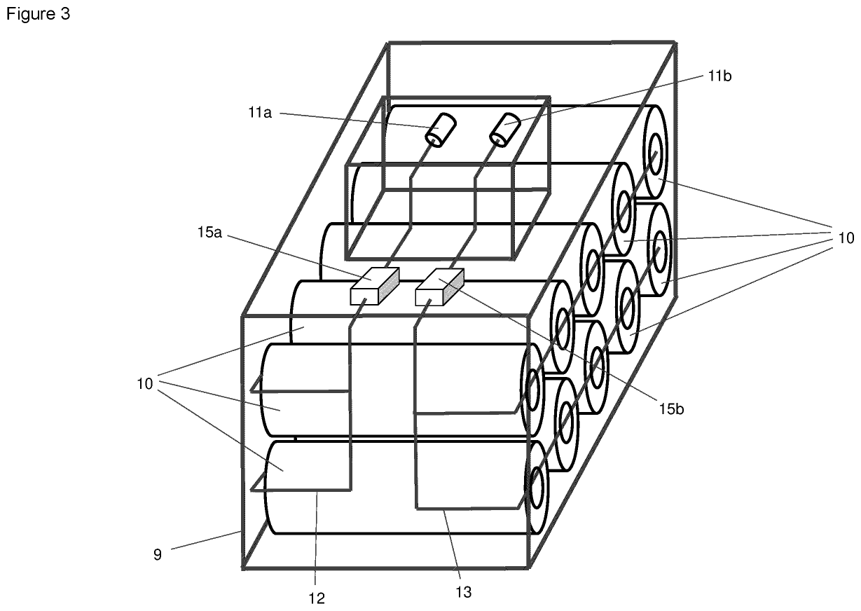

The interface device 11 additionally contains a positive terminal 11a and a negative terminal 11b (see FIG. 3). By means of these positive and negative terminals 11a, 11b, the DC voltage (direct current voltage) produced by the energy storage cells 10 can be supplied to a machine tool 1, which machine tool is connected to the rechargeable battery 8, via the positive and negative contacts of said machine tool. For this purpose, the interface device 11 of the rechargeable battery 8 is re-releasably connected to the battery interface 7 of the machine tool 1. The positive and negative contacts of the machine tool 1 are not shown in the figures.

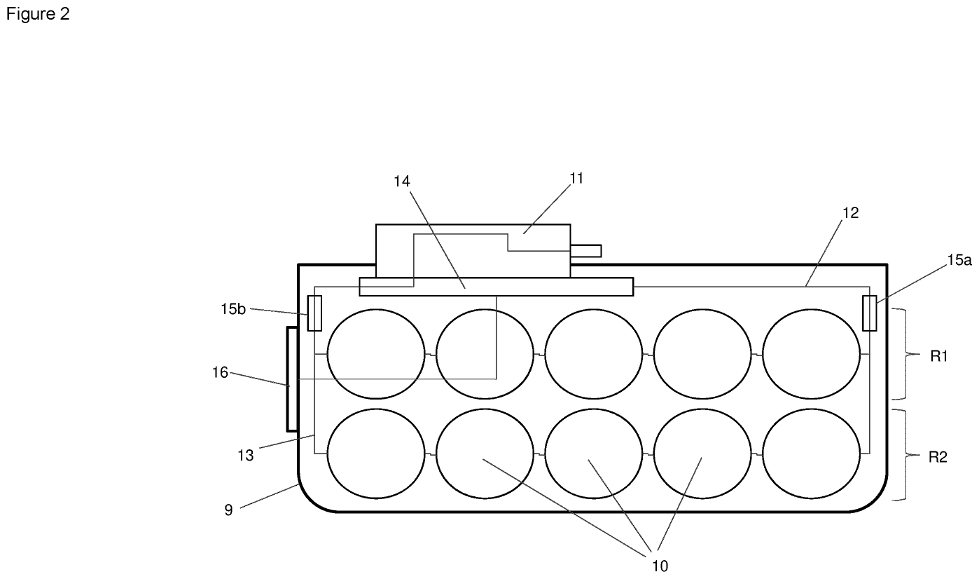

FIG. 2 shows a sectional side view through the rechargeable battery 8 together with its essential components.

As already mentioned above and shown in FIGS. 2 and 3, according to the exemplary embodiment in the figures, the rechargeable battery 8 contains a first row and second row R1, R2 of energy storage cells 10. The positive poles of the respective energy storage cells are electrically connected by the positive line 12 to the positive terminal 11a of the interface device 11, and negative poles of the respective energy storage cells 10 are electrically connected by the negative line 13 to the negative terminal 11b of the interface device 11. The energy storage cells 10 of the first row R1, and the energy storage cells 10 of the second row R2 are connected to one another in series. The first row R1 of energy storage cells 10 and the second row R2 of energy storage cells 10 are in turn connected in parallel.

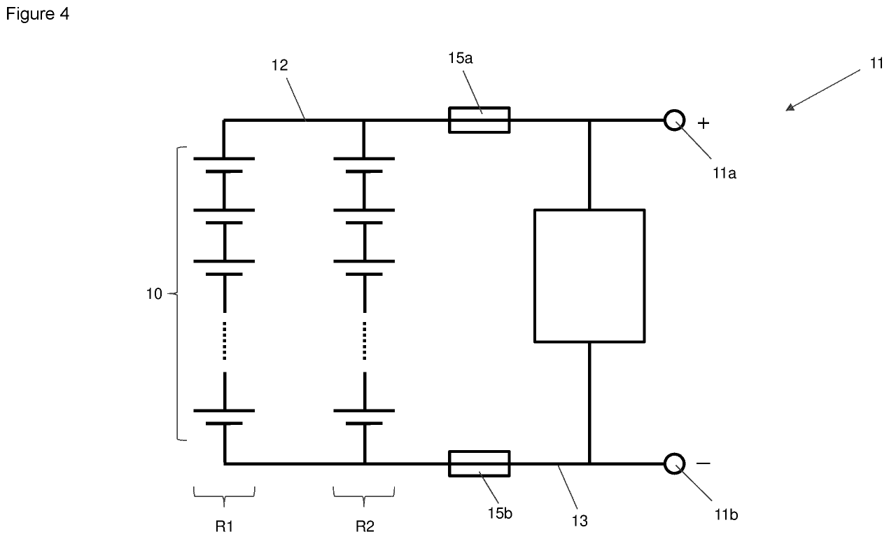

As shown in particular in FIGS. 3 and 4, according to a first exemplary embodiment of the rechargeable battery 8 according to the invention, a first overcurrent protection device 15a (also called a fuse) is positioned in the positive line 12, and a second overcurrent protection device 15b (also called a fuse) is positioned in the negative line 13.

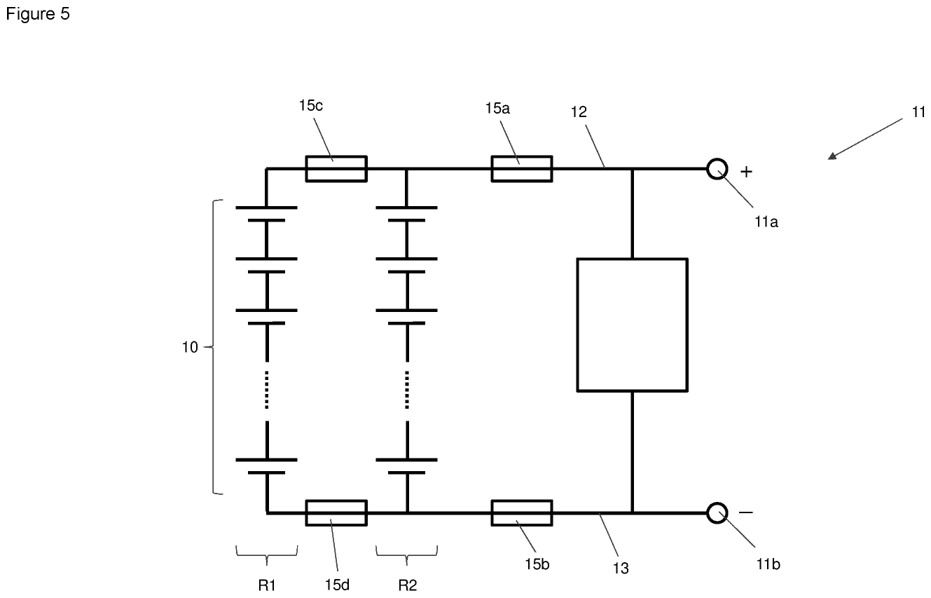

As shown in FIG. 5, according to a second exemplary embodiment of the rechargeable battery 8 according to the invention, a first and a second overcurrent protection device 15a, 15c are positioned in the positive line 12, and a first and a second overcurrent protection device 15b, 15d are positioned in the negative line 13. The first and second overcurrent protection devices 15a, 15c are positioned in series in the positive line 12, and the first and second overcurrent protection devices 15b, 15d are positioned in series in the negative line 13. It is also possible, however, for more than two overcurrent protection devices 15a, 15b, 15c, 15d to be positioned in series in the positive line or negative line 12, 13 in each case.

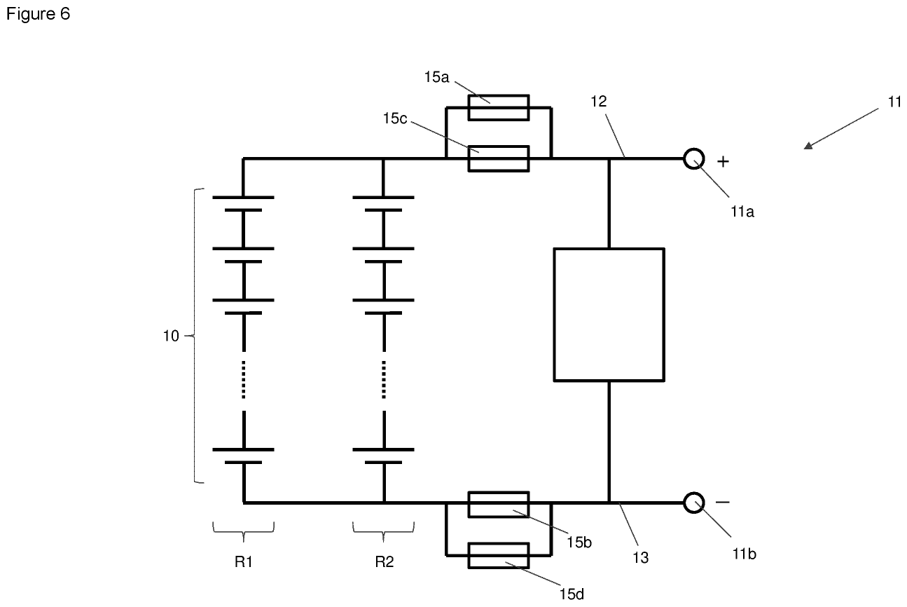

FIG. 6 shows a third exemplary embodiment of the rechargeable battery 8 according to the invention. Unlike the first exemplary embodiment of the rechargeable battery 8 according to the invention, a first and a second overcurrent protection device 15a, 15c are arranged in parallel in the positive line 12, and a first and a second overcurrent protection device 15b, 15d are arranged in parallel in the negative line 13. According to a further exemplary embodiment of the rechargeable battery 8, it is also possible for more than two overcurrent protection devices 15a, 15b, 15c, 15d to be positioned in parallel in the positive line 12 and/or in the negative line 13 in each case.

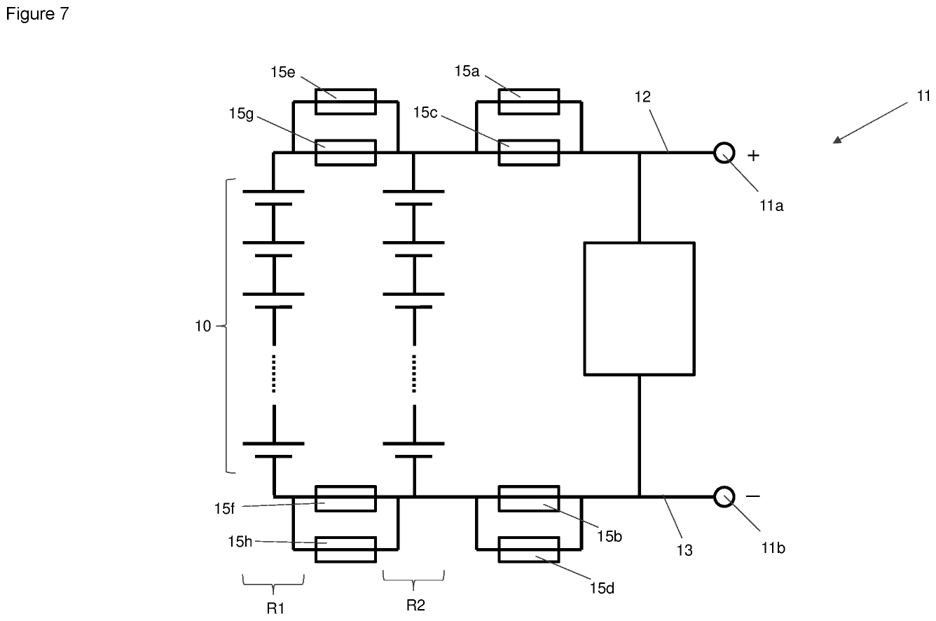

FIG. 7 shows a fourth exemplary embodiment of the rechargeable battery 8 according to the invention. According to this fourth exemplary embodiment, a first and a second overcurrent protection device 15a, 15c are arranged in parallel in the positive line 12, and a third and a fourth overcurrent protection device 15e, 15g are arranged in parallel in the positive line 12. Furthermore, a first and a second overcurrent protection device 15b, 15d are arranged in parallel in the negative line 13, and a third and a fourth overcurrent protection device 15f, 15h are arranged in parallel in the negative line 13.

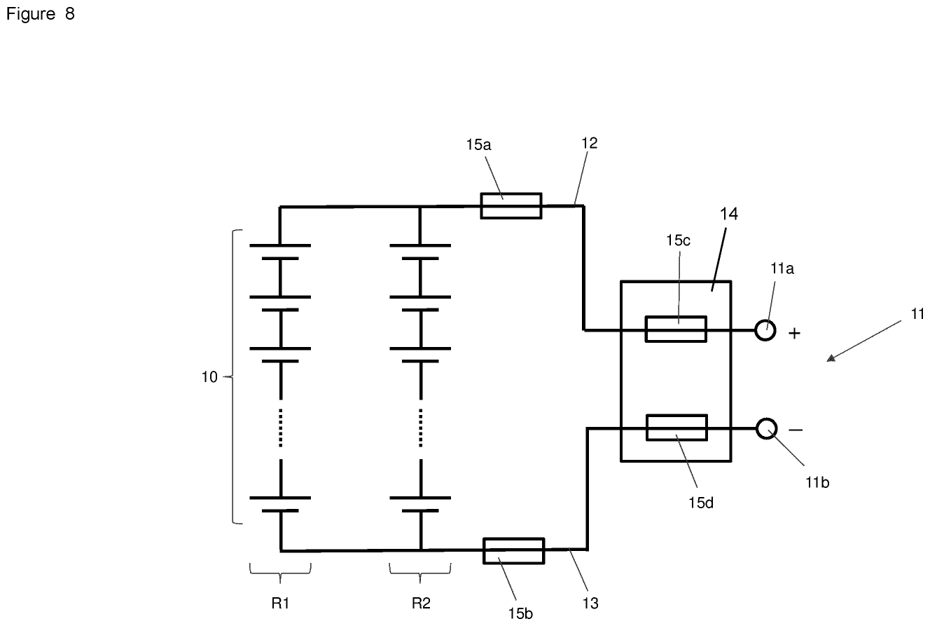

FIG. 8 shows a fifth exemplary embodiment of the rechargeable battery 8 according to the invention. According to this fifth exemplary embodiment, a first and a second overcurrent protection device 15a, 15c are positioned in the positive line 12, and a first and a second overcurrent protection device 15b, 15d are positioned in the negative line 13. As FIG. 8 shows, both the second overcurrent protection device 15c in the positive line 12 and the second overcurrent protection device 15d in the negative line 13 are positioned on the battery controller 14, which is in the form of a printed circuit board.

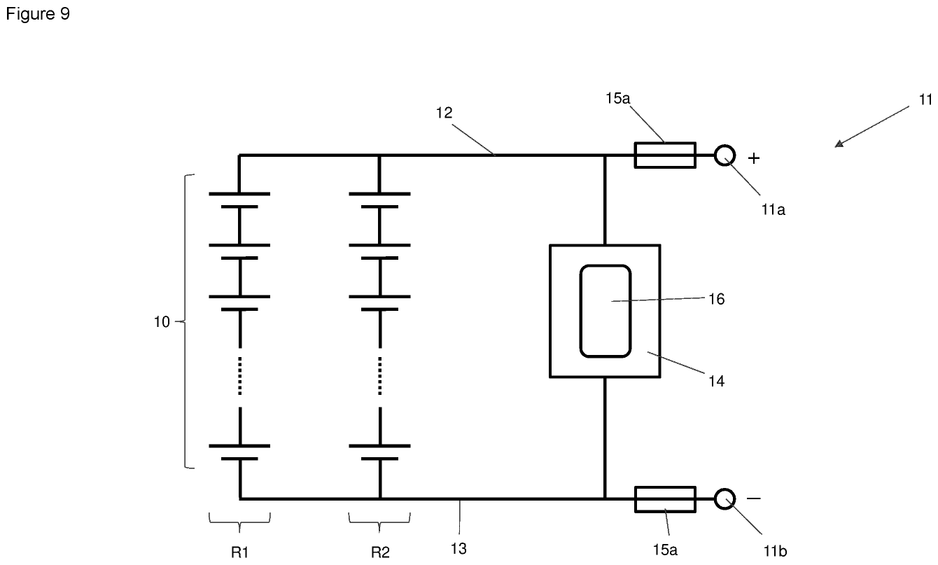

FIG. 9 shows a sixth exemplary embodiment of the rechargeable battery 8 according to the invention. According to this exemplary embodiment, an overcurrent protection device 15a is positioned in the positive line 12, and an overcurrent protection device 15b is positioned in the negative line 13. As FIG. 9 shows, the overcurrent protection device 15a in the positive line 12, and the overcurrent protection device 15b in the negative line 13, are each positioned before or after the battery controller 14. In the circuit diagram of FIG. 9, the energy storage cells 10 and the battery controller 14 are positioned in parallel with one another. The overcurrent protection device 15a in the positive line 12 and the overcurrent protection device 15b in the negative line 13 are in turn connected in series with the energy storage cells 10 and the battery controller 14. As FIG. 9 also shows, the battery controller 14 is connected to a display device 16. Data and information produced by the battery controller 14 and relating to the energy storage cells 10 can be displayed on the display device 16 for a user of the rechargeable battery 8.

By virtue of this serial arrangement of the overcurrent protection devices 15a, 15b with respect to the energy storage cells 10 and the battery controller 14, in the event of the overcurrent protection devices 15a, 15b interrupting the electrical circuit, the display device 16 can continue to be supplied with electrical power. A user of the rechargeable battery 8 can thereby continue to be supplied with information and data, in particular about the interruption in the circuit of the rechargeable battery 8 caused by an overcurrent protection device 15a, 15b.

As FIGS. 3 to 9 show, the battery controller 14 is connected to the positive line and negative line 12, 13. The battery controller 14 is used, inter alia, for monitoring the energy storage cells 10 and in particular the capacity or the voltage and current values of the energy storage cells 10.

### LIST OF REFERENCE SIGNS

1: machine tool
2: housing for the machine tool
2a: front end of the housing
2b: back end of the housing
2c: upper face of the housing
2d: lower face of the housing
3: handle
3a: top end of the handle
3b: front face of the handle
3c: bottom end of the handle
4: operating switch
5: tool holder
6: tool
7: battery interface
8: rechargeable battery
9: housing for the rechargeable battery
10: energy storage cell
11: interface device
11a: positive terminal
11b: negative terminal
12: positive line
13: negative line
14: battery controller
15a-15h: overcurrent protection device
16: display device
R1: first row of energy storage cells
R2: second row of energy storage cells

What is claimed is:

1-4. (canceled)

5: A rechargeable battery comprising:
a housing for accommodating at least one energy storage cell;
a positive line and a negative line for connecting the at least one energy storage cell to an interface device; and
at least one overcurrent protection device in the positive line or in the negative line.

6: The rechargeable battery as recited in claim 5 wherein the at least one overcurrent protection device is contained both in the positive line and in the negative line.

7: The rechargeable battery as recited in claim 5 wherein the at least one overcurrent protection device includes at least two overcurrent protection devices arranged in parallel with one another in the positive line or in the negative line.

8: The rechargeable battery as recited in claim 5 wherein the overcurrent protection device includes a fusible link.

9: A machine tool comprising the rechargeable battery as recited in claim 5 for supplying the machine tool with electrical power.
